(19) United States
(12) Patent Application Publication
(10) Pub. No.: US 2024/0010876 A1
(43) Pub. Date: Jan. 11, 2024

(54) ADHESIVE TAPE

(71) Applicant: tesa SE, Norderstedt (DE)

(72) Inventors: Felix Stephan VON LAMEZAN, Hamburg (DE); Jan AUGENSTEIN, Hamburg (DE); Alexander PRENZEL, Hamburg (DE)

(73) Assignee: tesa SE, Norderstedt (DE)

(21) Appl. No.: 18/038,620

(22) PCT Filed: Nov. 24, 2021
(86) PCT No.: PCT/EP2021/082897

§ 371 Date: May 24, 2023

(30) Foreign Application Priority Data
Nov. 24, 2020 (DE) 102020214722.1

(51) Int. Cl. C09J 7/25; C09J 7/38

(52) U.S. Cl. CPC C09J 7/255; C09J 7/385

(57) ABSTRACT

The invention relates to an adhesive tape comprising a backing consisting of a film, to at least one side of which backing an adhesive mass is applied. The film is a film that is monoxially stretched in the longitudinal direction and contains at least 90 wt. %, preferably 95 wt. %, more preferably 99 wt. % of polyester polymers.

This application is a 371 of International Patent Application No. PCT/EP2021/082897, filed Nov. 24, 2021, which claims priority of German Patent Application No. 10 2020 214 722.1, filed Nov. 24, 2020, the disclosures of which patent applications are hereby incorporated herein by reference.

The invention relates to an adhesive tape.

What are called strapping adhesive tapes are especially suitable for bundling of articles. Such articles are, for example, pipes, profiles or stacked boxes (strapping application). In addition, strapping applications include the fixing of moving parts in white goods (such as fridges and freezers or air conditioning units), in red goods such as (gas) stoves, and generally in electrical devices, for example printers.

In the technical jargon, the sectors are referred to as follows:
Appliance sector: fixing of moving parts of fridges and freezers and other domestic appliances such as gas stoves etc.
Office automation sector: fixing of moving parts of printers, copiers etc.

Further applications of such adhesive tapes are
a) the temporary fixing of relatively large components, for example car windshields, after insertion into the frame until the liquid PU adhesive has cured, in order to prevent slippage during the curing process,
b) what is called the endtabbing (end ply bonding) of metal coils with the aim of residue-free redetachability even at low temperatures,
c) the temporary closure of vessels or general bonding of surfaces with the requirement for residue-free redetachability even at low temperatures.

Residue-free removability (redetachability) of a (strapping) tape from various substrates depends essentially on the peel forces that evolve after different periods of time on detachment of the adhesive tape from the respective substrates. Ideally, the peel force does not increase at all, or does so only slightly, by comparison with the initial peel force, since there is a rising risk as the peel force increases that either the carrier will tear or residues will be left behind. Thus, the film carrier, in the case of excessively high forces, can fail and tear and/or rip open. Further results of excessively high peel forces may either be the cohesive splitting of the adhesive or else the adhesive failure of the adhesive through detachment from the carrier.

In all cases, the result is unwanted residues of the adhesive tape on the substrate, whether in the form of parts of the adhesive tape itself or parts of the adhesive.

In this respect, there is a need for a strapping adhesive tape that can be employed universally on all substrates of relevance for use, for example the plastics ABS, PS, PP, PE, PC, POM, PVC, HIPS, GPPS, such as various metals, such as solvent-based, water-based and powder-applied paints and other solvent-free paints (for example UV-curing paints), which sticks reliably to these substrates with sufficiently high adhesion forces of generally at least 2.5 N/cm, but can nevertheless be removed without residue or damage even after prolonged storage at different temperatures (temperature range: −20° C. to +60° C.) and/or UV irradiation.

These especially include surfaces such as PP, PE, PC, PS, HIPS, GPPS and steel.

Even though strapping adhesive tapes are utilized in very different applications, they have some essential properties in order that they fulfil the particular demands made on them. These are—without this enumeration making any claim to completeness—very high tensile strength (ultimate tensile strength), very good stretch resistance, corresponding to a high modulus of elasticity coupled with low stretching and low elongation at break, a peel adhesion force which is sufficient but not too high, a moderate peel adhesion force to its own reverse side, residue-free redetachability after the stresses of the actual use, robustness of the carrier toward mechanical stress, and, for some applications, stability of the adhesive tape to UV radiation and to many chemicals.

While some of the properties are attributable to the adhesive or other functional layers of the adhesive tape, extensibility and tensile strength are based essentially on the physical properties of the carrier material used.

There is a further disadvantage of the elevated peel adhesion forces of strapping adhesive tapes that should also not remain unmentioned at this point. This is that, with increasing peel adhesion forces, there is also a rising risk of damaging the substrate on removal, for example as a result of lifting of paint coatings.

Particularly in the case of rapid removal at sharp angles that are unfavorable, but do occur in practice, in the case of strapping adhesive tapes, even in the case of speed-dependent peel adhesion forces of more than 3 N/cm, there can be instances of tearing and splitting of the adhesive tape carrier in z direction, called shredding. At the same time, such peel adhesion forces also place elevated demands on the efficacy of the primer or on the anchoring of the adhesive on the film carrier and on the cohesion of the adhesive. This problem becomes more acute at low temperatures of less than 0° C. Even at these low temperatures, the adhesive tape must not show any shredding.

An adhesive tape which is to find use as a (strapping) adhesive tape should thus have the following properties:
The adhesive tape must secure loose parts during transport, meaning that the adhesive tape should have high tear resistance in machine direction and adequate peel adhesion forces.
The adhesive tape must not stretch significantly under stress, meaning that the adhesive tape should have high F5% [high tensile strength values at 5% elongation] or a high modulus of elasticity.
The adhesive tape must function under a variety of climatic conditions, meaning that the adhesive tape should have climatic stability within a temperature range between −20° C. and 40° C. and a relative humidity of up to 95%.
The adhesive tape should be removable again without residue within a temperature range between −20° C. and 40° C. and a relative humidity of up to 95%.
The adhesive tape should be heat-resistant on drying of the adhesive coating in the process for producing the adhesive tape.
The adhesive tape should be easy to use, meaning that the adhesive tape should preferably have a low unwind force, which can especially be assured via the use of a carbamate or silicone release.
The adhesive tape should have good bonding to various substrates and have sufficient cohesion to secure the goods being transported, meaning that the adhesive tape may have an adhesive based on natural rubber, synthetic rubber or acrylate.

The prior art encompasses adhesive tapes that are used in the field of strapping (bundling), appliance (in-transit securing of moving parts such as drawers, shelves, flaps, especially in domestic appliances etc.) and in the furniture industry, and, when used for other applications, show weaknesses in the removal of the adhesive tape from the substrate in the lower temperature range (below about 10° C.).

It is known that unstretched, i.e. unoriented, films made of polyolefins or polyamides, for example, on account of their toughness, offer a certain resistance to tear propagation. This type of film, however, because of the system-related high elongation, is less suitable as an adhesive tape carrier for applications with high longitudinal and transverse stress.

There are mainly two different films that are used as carrier materials for strapping adhesive tapes:
i) biaxially oriented PET films having a thickness between 30 and 60 μm
ii) monoaxially oriented PP films having a thickness between 40 and 150 μm

Biaxially stretched PET carriers are known to be advantageous over monoaxially stretched PP carriers (MOPP) because of their higher split resistance, but tear at an earlier stage in longitudinal direction (machine direction, MD) than MOPP. Both types of film, because of their high modulus of elasticity (especially in the case of BOPET films), have comparatively low stretchability under tensile stress in use, i.e. are of good suitability. Strapping adhesive tapes made of MOPP are generally used for palletization; the film does not split on removal because the paper splits readily at the surface. Use of MOPP film for surface protection adhesive tapes has been possible to date only when the adhesive adheres so weakly that no remnants of adhesive or adhesive tape residue are left behind with a fraction of the film. There is thus a need to provide an adhesive tape for surface protection applications, for example as in-transit securing for PC printers, refrigerators, electrical or gas stoves or furniture, which has high adhesion but is removable without residue, especially also below customary room temperature, i.e., for example, between −20° C. and +7° C. With falling temperature, there is a drop in the strength of a polypropylene film, and simultaneously a rise in the peel adhesion force of the adhesive. The challenge is to minimize this behavior under cold conditions and to find a solution to the technical problem through a suitable combination of film and adhesive.

Many of the known strapping adhesive tapes have a monoaxially stretched polypropylene (MOPP) carrier, since MOPP has very high force absorption in machine direction (MD). Because of the stretching in machine direction (x direction, MD), there is a decrease in the toughness of the MOPP carrier in y direction (cross direction, CD) and in z direction (the thickness of the film is determined in z direction), and hence the internal strength of the MOPP film becomes the weak point. Consequently, the carrier frays, and the adhesive and film residues remain on the substrate, which is a common cause for complaint.

The weak point of MOPP is low strength in cross direction (CD) and within the film in z direction. This effect is increased at relatively low temperatures (−20° C.), since the temperature reaches or goes below glass transition temperature of polypropylene (between 0 and −20° C.) and the carrier becomes very brittle. This effect is particularly marked when a PP homopolymer is used, since the regular arrangement of the polymer chains gives rise to high crystallinity, which makes the film very firm, stiff and brittle. Particularly for applications at low temperatures, there are heterophasic PP copolymers where an ethylene-propylene copolymer (EP phase) is mixed in or polymerized in fine distribution in the PP homopolymer matrix. The presence of the EP phase increases the toughness of the PP homopolymer matrix.

A known approach is to use a softer carrier. The standard method of doing so is to mix in polyethylene in order to lower the glass transition temperature and maintain higher flexibility of the carrier at lower temperatures. This improves the tendency to fray at lower temperatures, but cannot eliminate it completely. An adverse effect here, however, is a reduction in the strength of a corresponding film. In order to be able to offer a robust and shredding-free solution, an adhesive with lower peel adhesion forces at low temperatures on the adhesive tape is used. But since the market is demanding comparatively higher peel adhesion forces at low temperatures, in order to be able to assure in-transit securing, a different carrier has to be chosen.

A commonly occurring problem in the case of MOPP films, in addition to shredding, is the occurrence of fibers in the cutting and finishing process in the removal of the adhesive tape. The fibers formed have a great influence on processing reliability, production speed and product quality. Fiber-free films can increase production speed by at least 100%, if not 400% or more. Furthermore, the process becomes more efficient since there is no need for complex cleaning operations. If an optical fault recognition system is used in production, the occurrence of fibers and fiber agglomerates often leads to triggering of fault recognition and hence to stoppages in the production process.

EP 3 585 849 A1 and EP 3 585 850 A1 each disclose an adhesive tape with a carrier made of a film with an adhesive applied to at least one side thereof, wherein the film is a monoaxially stretched film consisting to an extent of at least 95 wt %, preferably to an extent of 99 wt %, further preferably to an extent of 100 wt %, of propylene polymer composition with different phases.

It is an object of the invention to achieve a noticeable improvement over the prior art and to provide an adhesive tape which is of very simple construction and hence inexpensively producible, which has very high tear propagation resistance in cross direction (cd) and longitudinal direction (machine direction, md) and at the same time high tensile strength in longitudinal direction (md) and which is removable from the surface after use without residue, without shredding and without tearing of the carrier.

This object is achieved by an adhesive tape as characterized in detail in the main claim. The dependent claims describe advantageous embodiments of the invention. Additionally encompassed by the concept of the invention are uses of the adhesive tape of the invention.

Accordingly, the invention relates to an adhesive tape with a carrier made of a film with an adhesive applied to at least one side thereof, wherein the film is a film that has been monoaxially oriented in longitudinal direction (machine direction) and contains polyester polymers to an extent of at least 90 wt %, preferably 95 wt %, further preferably 99 wt %.

In a first preferred embodiment of the invention, the film consists to an extent of 100 wt % of polyester polymers. In that case, no further polymers are present in the matrix of the film.

The fractions in the film to make the composition up to 100 wt % may consist of other polymers to be added to the polyester polymers.

The following polyesters may be used:
PBT: polybutylene terephthalate, a polymer of terephthalic acid
PLA: polylactide, the biodegradable polymer of lactic acid
PTT: polytrimethylene terephthalate
PEN: polyethylene naphthalate
PC: polycarbonate, an ester of carbonic acid
PEC: polyester carbonate and carboxylic esters, and also esters of carbonic acid
PAR: polyarylates, aromatic polyesters

Particular preference is given to using polyethylene terephthalate, a polymer of terephthalic acid, as polyester or polyethylene terephthalate copolymer, further preferably polyethylene terephthalate or polyethylene terephthalate copolymer as the sole polyester.

Polyethylene terephthalate in the context of the present invention is understood to mean a polycondensate of ethylene glycol and terephthalic acid which is preferably a homopolymer, but may also be in the form of a blend or in pure form as the copolymer (for example PET G™). In that case, a comonomer, for example diethylene glycol or cyclohexanedioldimethanol, is present in proportions of preferably not more than 5 wt %, further preferably of not more than 1 wt %.

The polyethylene terephthalate copolymer in the context of this invention contains a small proportion of comonomer of not more than 5 wt %.

Aside from the matrix polymer, the polymer composition of the invention may contain other components, for example conventional additions such as dyes, nucleating agents, fillers, antioxidants, radiation stabilizers etc. Particular preference is given to the use of inorganic, organic or polymeric nucleating agents.

The polymer composition of the invention may be prepared for use by mixing the components, preferably in an extruder. The additional components can advantageously be mixed or blended directly in the melting extruder for production of the polymer film. For this purpose, it is customary to use a single-screw extruder. But the components can also be mixed in a separate step, for example with the aid of a twin-screw extruder.

The film of the adhesive tape of the invention is obtained by extrusion and stretching in longitudinal direction using customary, commonly known methods.

For this purpose, after the cooling of the melt, the film is preferably heated again very uniformly to a temperature above the glass transition point T_{g}, but below the melting point, in order then to stretch the film between rolls running at different speeds, advantageously by stretching across a short gap, i.e. between two rolls only. The film is then subjected to heat treatment in downstream annealing rolls in order to reduce shrinkage.

The stretching ratio in the stretching of the film, especially extruded film in longitudinal direction (machine direction), is preferably between 1:3 and 1:10, more preferably between 1:3 and 1:7, most preferably between 1:4 and 1:6.

A stretching ratio of 1:7 indicates that a section of the film of, for example, length 1 m gives rise to a section of the stretched film of length 7 m. The stretching is effected without any significant decrease in the width of the film, mainly at the expense of the thickness of the film.

The customary film thickness after stretching is between 20 and 150 μm, preferably 25 to 100 μm, more preferably 30 to 50 μm.

The film of the invention may also advantageously contain inorganic or organic particles for adjustment of surface topography or appearance (gloss, haze etc.). Such particles are, for example, calcium carbonate, apatite, silicon dioxide, titanium dioxide, aluminum oxide, crosslinked polystyrene, crosslinked polymethylmethacrylates, zeolites and other silicates such as aluminum silicates. These particles—called antiblocking agents—are used to improve winding properties. Particularly preferred particles here are calcium carbonate or, more preferably, silicon dioxide. These compounds are generally used in amounts of 0.01 to 5 parts by weight, preferably of 0.01 to 0.5 parts by weight and ideally of 0.01 to 0.3 parts by weight. The proportions by weight are based on the mass of polymer in the film.

The particle size (d₅₀) of the particles used (especially the antiblocking agents), i.e. the median, in production is generally between 0.1 and 0.8 μm and preferably between 0.3 and 5.5 μm and more preferably between 0.5 and 2.5 μm. If particles having a d₅₀ greater than 8 μm are used, the impression of a gray surface is increased and the gloss of the film surface is reduced.

Particle size analysis is effected by laser diffraction (ISO13320-1 (1999-11)).

The proportion of particles, preferably color pigments, in the film layer is preferably within a range from 0.5 to 10 parts by weight, further preferably within a range from 1 to 8 parts by weight, based on the weight of polymer (mass of polymer) in the film.

The composition of the film in that case is especially (parts by weight based in each case on the weight of polymer (mass of polymer) in the film):
100 parts by weight of polyester, especially polyethylene terephthalate
0.5 to 10 parts by weight of particles, preferably color pigments, further preferably 1 to 8 parts by weight

In the context of the invention, there may be a corona, plasma or else flame pretreatment of the side of the film carrier that is to be coated with the adhesive at a later stage, in order to better anchor the adhesive on the carrier.

Adhesion, meaning the anchoring of the adhesive on the carrier, can be improved by the use of primers. These can firstly adjust the surface energy in a productive manner and secondly, for example when isocyanate-containing primers are used, pursue the aim of chemical attachment of the elastomeric adhesive component to the carrier.

The customary weight per unit area at which the primer is applied is between 0.1 and 10.0 g/m², further preferably between 0.4 and 2.0 g/m².

A further means of improving anchoring is that of using carrier films that are provided in a targeted manner with a polymer surface favorable for binding to the pressure-sensitive adhesive by coextrusion on the part of the film manufacturer.

Descriptions of the adhesives that are customarily used for adhesive tapes, and of release varnishes and primers, can be found, for example, in the “Handbook of Pressure Sensitive Adhesive Technology” by Donatas Satas (van Nostrand, 1989).

The adhesive applied to the carrier material is preferably a pressure-sensitive adhesive, i.e. an adhesive which, even under relatively gentle contact pressure, permits a durable bond to virtually all substrates and can be detached again after use from the substrate essentially without residue. A pressure-sensitive adhesive is permanently pressure-sensitively tacky at room temperature, i.e. has sufficiently low viscosity and high touch-tackiness, such that it wets the surface of the respective substrate even at low contact pressure. The bondability of the adhesive is based on its adhesive properties, and its redetachability on its cohesive properties.

In order to produce an adhesive tape from the carrier, it is possible to make use of any of the known adhesive systems. As well as the preferred adhesives based on natural or synthetic rubber, silicone adhesives are usable, as are polyacrylate adhesives, preferably a low molecular weight acrylate hotmelt pressure-sensitive adhesive.

Preference is given to using an adhesive chosen out of the group of the natural rubbers, the synthetic rubbers, or any blend of natural rubbers and synthetic rubbers, where the proportion of the synthetic rubber in the blend, in a preferred variant, is at most as high as the proportion of natural rubber.

Rubber adhesives show a good combination of peel adhesion force, tack and cohesion, and balanced bonding characteristics on virtually all bonding substrates of relevance, and are thus ideal. General information relating to rubber adhesives can be found in, inter alia, standard works for adhesive tapes, for example the “Handbook of Pressure Sensitive Adhesive Technology” by Donatas Satas.

The natural rubber(s) may in principle be chosen from all available qualities, for example crepe, RSS, ADS, TSR or CV types, according to the required level of purity and viscosity, and the synthetic rubber(s) from the group of the randomly copolymerized styrene-butadiene rubbers (SBR), the butadiene rubbers, (BR), the synthetic polyisoprenes (IR), the butyl rubbers, (IIR), the halogenated butyl rubbers (XIIR), the acrylate rubbers (ACM), the ethylene-vinyl acetate copolymers (EVA) and polyurethanes and/or blends thereof.

Further preferably, thermoplastic elastomers can be added to the rubbers, in order to improve processibility, with a proportion by weight of 10 to 50 wt %, based on the total elastomer content.

Particular mention should be made in a representative manner at this point of the particularly compatible styrene-isoprene-styrene (SIS) and styrene-butadiene-styrene (SBS) types. Suitable elastomers for blending are also, for example, EPDM or EPM rubber, polyisobutylene, butyl rubber, ethylene-vinyl acetate, hydrogenated block copolymers of dienes (for example by hydrogenation of SBR, cSBR, BAN, NBR, SBS, SIS or IR; such polymers are known, for example, as SEPS and SEBS) or acrylate polymers such as ACM. In addition, a 100% system composed of styrene-isoprene-styrene (SIS) has been found to be suitable.

Crosslinking is advantageous for improvement of the redetachability of the adhesive tape after use, and can be effected thermally or by irradiation with UV light or electron beams. For the purpose of thermally induced chemical crosslinking, all previously known thermally activatable chemical crosslinkers are usable, such as accelerated sulfur or sulfur donor systems, isocyanate systems, reactive melamine, formaldehyde and (optionally halogenated) phenol-formaldehyde resins, or reactive phenolic resin or diisocyanate crosslinking systems with the appropriate activators, epoxidized polyester and acrylate resins, and combinations thereof.

The crosslinkers are preferably activated at temperatures above 50° C., especially at temperatures of 100° C. to 160° C., most preferably at temperatures of 110° C. to 140° C. The crosslinkers can also be thermally excited by IR rays or high-energy alternating fields.

Solvent-based adhesives, water-based adhesives or else adhesives in the form of a hotmelt system are usable. Also suitable is an acrylate hotmelt-based adhesive, where this may have a K value of at least 20, especially greater than 30, obtainable by concentrating a solution of such a composition to give a system processible as a hotmelt.

The concentration can take place in correspondingly equipped tanks or extruders; in particular, a vented extruder is preferred in the case of associated outgassing.

Such adhesive is detailed in DE 43 13 008 A1, the content of which is hereby incorporated by reference, and the content of which is incorporated into this disclosure and invention. The acrylate hotmelt-based adhesive may alternatively be chemically crosslinked.

In a further embodiment, self-adhesive compositions used are copolymers of (meth)acrylic acid and esters thereof having 1 to 25 carbon atoms, maleic acid, fumaric acid and/or itaconic acid and/or esters thereof, substituted (meth)acrylamides, maleic anhydride and other vinyl compounds, such as vinyl esters, especially vinyl acetate, vinyl alcohols and/or vinyl ethers.

The residual solvent content should be below 1 wt %.

An adhesive which is likewise found to be suitable is a low molecular weight hotmelt pressure-sensitive adhesive as classified by BASF under the acResin UV or Acronal® name, especially Acronal® DS 3458. This adhesive with low K value acquires its application-appropriate properties by virtue of a final radiatively initiated crosslinking operation.

Finally, it should be mentioned that polyurethane- or polyolefin-based adhesives are also suitable.

In order to optimize the properties, the self-adhesive composition used may be blended with tackifiers (resins) and/or one or more admixtures such as plasticizers, fillers, pigments, UV absorbers, light stabilizers, aging stabilizers, crosslinkers, crosslinking promoters or elastomers.

The term “tackifier resins” is understood by the person skilled in the art to mean a resin-based substance which increases tackiness.

Tackifiers are, for example, especially hydrogenated and unhydrogenated hydrocarbon resins (for example composed of unsaturated C₅ or C₇ monomers), terpene-phenol resins, terpene resins formed from raw materials such as α- or β-pinene and/or δ-limonene, aromatic resins such as coumarone-indene resins or resins formed from styrene or α-methylstyrene, such as rosin and conversion products thereof such as disproportionated, dimerized or esterified resins, in which case glycols, glycerol or pentaerythritol may be used. Aging-stable resins without an olefinic double bond are particularly suitable, for example hydrogenated resins.

Reference is made explicitly to the representation of the state of knowledge in the “Handbook of Pressure Sensitive Adhesive Technology” by Donatas Satas (van Nostrand, 1989).

It is possible to add customary admixtures such as aging stabilizers (antiozonants, antioxidants, light stabilizers etc.) to the adhesive for the purpose of stabilization.

The following additives to the adhesive are typically utilized:
plastifying agents, for example plasticizer oils or low molecular weight liquid polymers, for example low molecular weight polybutenes
primary antioxidants, for example sterically hindered phenols
secondly antioxidants, for example phosphites or thiosynergists (thioethers)
process stabilizers, for example C radical scavengers
light stabilizers, for example UV absorbers or sterically hindered amines
processing auxiliaries
wetting additives
adhesion promoters
end block reinforcer resins and/or
optionally further polymers that are preferably elastomeric in nature; correspondingly utilizable elastomers include, inter alia, those based on pure hydrocarbons, for example unsaturated polydienes such as natural or synthetically produced polyisoprene or polybutadiene, chemically essentially saturated elastomers, for example saturated ethylene-propylene copolymers, α-olefin copolymers, polyisobutylene, butyl rubber, ethylene-propylene rubber, and chemically functionalized hydrocarbons, for example halogenated, acrylated, allyl ether- or vinyl ether-containing polyolefins
fillers such as fibers, carbon black, zinc oxide, titanium dioxide, solid microbeads, solid or hollow glass beads, silica, silicates, chalk.

Suitable fillers and pigments are, for example, fibers, carbon black, zinc oxide, titanium dioxide, solid microbeads, solid or hollow glass beads, silica, silicates, chalk, carbon black, titanium dioxide, calcium carbonate and/or zinc carbonate.

Suitable aging stabilizers (antiozonants, antioxidants, light stabilizers etc.) for the adhesives are primary antioxidants, for example sterically hindered phenols, secondary antioxidants, for example phosphites or thiosynergists (thioethers) and/or light stabilizers, for example UV absorbers or sterically hindered amines.

Suitable plasticizers are, for example, aliphatic, cycloaliphatic and aromatic mineral oils, di-or polyesters of phthalic acid, trimellitic acid or adipic acid, liquid rubbers (for example nitrile or polyisoprene rubbers), liquid polymers of butene and/or isobutene, acrylic esters, polyvinylethers, liquid and soft resins based on the raw materials for tackifying resins, wool wax and other waxes or liquid silicones.

Crosslinking agents are, for example, phenolic resins or halogenated phenolic resins, melamine resins and formaldehyde resins. Suitable crosslinking promoters are, for example, maleimides, allyl esters such as triallyl cyanurate, polyfunctional esters of acrylic acid and methacrylic acid.

The substances enumerated are again not obligatory; the adhesive will function even without addition of these, individually or in combination, i.e. without resins and/or residual admixtures.

The coating thickness of adhesive is preferably within a range from 15 to 60 g/m², preferably between 20 and 40 g/m².

The pressure-sensitive adhesives can be produced and processed from solution, from dispersion and from the melt. Preferred production and processing methods are from solution or dispersion.

The pressure-sensitive adhesives thus produced can then be applied to the carrier by the commonly known methods. In the case of processing from the melt, these may be application methods via a nozzle or calender.

Known methods from solution include coating operations with doctor blades, knives or nozzles, to name just a few.

The adhesive in conjunction with the film mentioned enables residue-free removal within the range of the customary use temperature of between −20° C. and +40° C.

The general expression “adhesive tape” in the context of this invention encompasses all two-dimensional structures such as films or film sections having a two-dimensional extent, tapes of extended length and limited width, tape sections and the like, and lastly also diecuts or labels.

The adhesive tape may either be produced in the form of a roll, i.e. in the form of an Archimedean spiral rolled onto itself, or covered on the adhesive side with release materials such as siliconized paper or siliconized film.

A preferentially suitable release material is a non-linting material such as a polymer film or a well-sized long-fiber paper.

The adhesive tapes especially have running lengths of 25 to 100 m in the form of the customary adhesive tape rolls, and of 1000 to 30,000 m in the form of spools.

On the reverse face of the adhesive tape, a reverse-face varnish may be applied in order to favorably influence the unrolling properties of the adhesive tape that has been wound into an Archimedean spiral. This reverse-face varnish may have been modified with silicone or fluorosilicone compounds and with polyvinylstearylcarbamate, polyethyleneiminestearylcarbamide or organofluorine compounds as anti-adhesive substances.

Suitable release agents include surfactant-based release systems based on long-chain alkyl groups, such as stearylsulfosuccinates or stearylsulfosuccinamates, but also polymers that may be selected from the group consisting of polyvinylstearylcarbamates, polyethyleneiminestearylcarbamides, chromium complexes of C₁₄ to C₂₈ fatty acids and stearyl copolymers, as described, for example, in DE 28 45 541 A. Likewise suitable are release agents based on acrylic polymers with perfluorinated alkyl groups, silicones or fluorosilicone compounds, for example based on poly(dimethylsiloxanes). More preferably, the release layer comprises a silicone-based polymer. Particularly preferred examples of such silicone-based release polymers include polyurethane- and/or polyurea-modified silicones, preferably organopolysiloxane/polyurea/polyurethane block copolymers, more preferably those as described in example 19 of EP 1 336 683 B1, most preferably anionically stabilized polyurethane- and urea-modified silicones with a proportion by weight of silicone of 70% and an acid number of 30 mg KOH/g. The use of polyurethane- and/or urea-modified silicones has the effect that the products of the invention, coupled with optimal aging resistance and universal inscribability, have optimized release characteristics. In a preferred embodiment of the invention, the release layer comprises 10 to 20 wt %, more preferably 13 to 18 wt %, of the release constituent.

In addition to the release layer, an antistatic coating may be present on the top side of the film, for example in the form of amine or amide waxes, for example Atmer (Croda) or Argued T50. This coating is advantageous because static adhesion of the adhesive tape to fingers and articles is prevented.

Adhesive tapes of the invention are preferably used in widths of 9 to 50 mm, especially 19 to 25 mm, and have a preferred thickness of 40 to 200 μm, preferably 50 to 180 μm, further preferably 60 to 120 μm.

Widths of rolls that are typically chosen are 10, 15, 19, 25, 30 and 50 mm.

FIG. 7 shows a typical construction of the adhesive tape of the invention.

The product consists of a film (a) and an adhesive (b). In addition, it is also possible to use a primer (c) to improve the adhesion between adhesive and carrier, and a reverse-side release (d).

The carrier (a) consists of a monoaxially oriented polyester film having a preferred thickness between 30 and 50 μm.

The adhesive (b) is a mixture of natural rubber or other elastomers and various resins, and may optionally also contain plasticizers, fillers and aging stabilizers.

The pressure-sensitive adhesives can be produced and processed from solution, from dispersion and from the melt. Preferred production and processing methods are from solution and from the melt. Particular preference is given to manufacturing the adhesive from solution, especially by using batch methods or continuous methods.

The pressure-sensitive adhesives thus produced can then be applied to the carrier by the commonly known methods. In the case of processing from the melt, these may be application methods via a nozzle or a calender.

Known methods from solution include coating operations with doctor blades, knives or nozzles, to name just a few.

The adhesive tape has excellent usability as strapping adhesive tape for bundling and palletizing of cardboard boxes and other goods, and as in-transit securing means and also for reinforcing at exposed and intricate edges, even at low temperatures.

In addition, the adhesive tape has excellent usability for fixing of moving parts such as doors, flaps etc. in printers or refrigerators during transport from the manufacturer to the retailer, or onward to the buyer, even at low temperatures.

The adhesive tape of the invention, on account of the properties outlined, also has advantageous usability in the following applications:
a) In the temporary fixing of relatively large components, for example windshields of cars after insertion into the frame until the liquid PU adhesive has cured, in order to prevent slippage during the curing process.
b) In the endtabbing (end ply bonding) of metal coils, with the demand for residue-free redetachability even at low temperatures.
c) In the temporary closing of vessels or general sticking of surfaces, with the requirement for residue-free redetachability even at low temperatures.

Distinctly reduced splitting of the carrier under cold conditions is observed; in addition, the adhesive tapes are redetachable without leaving a residue.

The invention described here, by virtue of elevated inner strength, solves the problem of fiber formation in the cutting and finishing process.

The invention is elucidated in detail hereinafter by one example and two comparative examples, without wishing to restrict the invention thereby.

### EXAMPLE

A total of three adhesive tape strips are examined, each with dimensions of length 150 mm and width 15 mm.

The carrier used in comparative example 1 (CE 1 for short hereinafter) is a MOPP film, i.e. a polypropylene film that has been monoaxially stretched in longitudinal direction, the carrier used in comparative example 2 (CE 2 for short hereinafter) is a BOPET film, i.e. a polyester film stretched biaxially in transverse and longitudinal direction, and the carrier used in example 1 (E 1 for short hereinafter) is an inventive MOPET film, i.e. a polyester film stretched monoaxially in longitudinal direction.

### Production of the Films

The respective polymers are melted using a single-screw extruder (at temperatures between 160 and 240° C.). The melt is shaped by a slot die to a film and laid out and chilled on a chill roll (at temperatures between 60 and 100° C.). With the aid of a monoaxially stretching unit, the films are stretched by the short stretching gap method at stretch rates of 1:5 to 1:9 (CE 1: 1:6 ; CE 2: 1:3 (longitudinal) and 1:3 (transverse); E 1: 1:5), and then subjected to heat treatment at a temperature of 127° C. and finally rolled up.

TABLE 1
Mechanical properties of the various films

| | CE 1 | CE 2 | E 1 |
|---|---|---|---|
| | MOPP | BOPET | MOPET |
| Thickness [μm] | 85 | 36 | 36 |
| Elongation at break | 25 | 140 | 25 |
| [%] | | | |
| Fmax [N/cm] | 240 | 80 | 140 |
| Modulus of | 2500 | 4500 | 9000 |
| elasticity [MPa] | | | |

The parameters measured are thickness, elongation at break, ultimate tensile strength Fmax and modulus of elasticity.

It is found that the MOPET film has a very high modulus of elasticity

| | |
|---|---|
| MOPP | 2500 MPa |
| BOPET | 4500 MPa |
| MOPET | 9000 MPa |

a very high tear strength in machine direction

| | |
|---|---|
| MOPP | 2.7 N/mm |
| BOPET | 5.9 N/mm |
| MOPET | 9.7 N/mm |

and high impact resistance in cross direction

| | | |
|---|---|---|
| MOPP | 106 | kJ/m² |
| BOPET | 1240 | kJ/m² |
| MOPET | 438 | kJ/m² |

FIG. 8 shows the result of the stress/strain test.

The result that can be inferred therefrom is that the mechanical data measured theoretically in the laboratory are reflected positively in the performance of the adhesive tape in the application test, especially in the vibration test according to DIN EN 60068-2-6:2008-10-00. The following should be mentioned here:
i) High modulus of elasticity of the carrier
   For E1, this prevents excessive stretching of the adhesive tape and hence loss of securing of the parts to be bonded. In the vibration test, excessive stretching was observed particularly for CE 2 at edge bonds (see, for example, position in FIG. 3, detail top right).
ii) The high ultimate tensile strength of the carrier
   In the vibration test for E 1, this prevented tearing of the adhesive tape. CE 2, which has the same thickness as E 1, tore in FIG. 5b, for example, whereas E 1 was unimpaired.
iii) High tear strength and high tear propagation resistance
   In the vibration test, CE 1 and CE 2 failed at multiple positions through tear propagation. Examples here include all regions of the positions shown in FIGS. 3, 4 and 5. E 1 did not show tear propagation in any of the positions mentioned. CE 1 showed particular weakness in positions 4a and 4b.

Overall, the properties detailed lead to an adhesive tape that withstood any stress that could be simulated by DIN EN 60068-2-6:2008-10-00. E1 thus constitutes a solution to a problem that could be solved previously only to a limited degree, if at all, by CE 1 and CE 2.

### BRIEF DESCRIPTION OF THE DRAWINGS

FIGS. 1 to 6 show the results of the vibration test.

FIG. 1 shows the open refrigerator in which short adhesive tape strips are used in different places to fix flaps or drawers in the refrigerator. These sites correspond to those that are typically utilized for in-transit securing in refrigerators on the way from production to the retailer, and subsequently to the final customer.

FIG. 2 shows the refrigerator fixed on a vibrator plate for the experiment.

FIG. 3 shows the different failure images of the adhesive tape according to comparative example 1. These split in the middle and partly become detached.

FIGS. 4a and 4b show the adhesive tape split in longitudinal direction according to comparative example 2 on the refrigerator door.

FIGS. 5a and 5b show the adhesive tape according to example 1 that neither splits nor becomes detached.

FIG. 6 gives a tabular overview of the places in which each adhesive tape failed after the vibration test.

FIG. 7 shows a typical construction of the adhesive tape of the invention.

FIG. 8 shows the result of the stress/strain test.

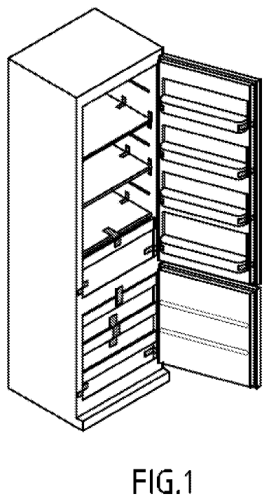

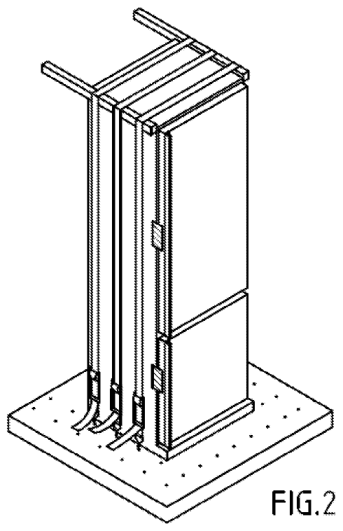

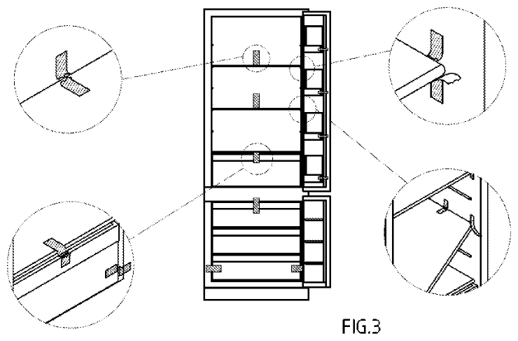

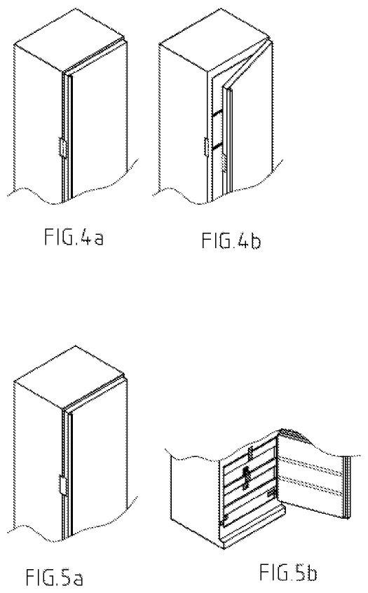

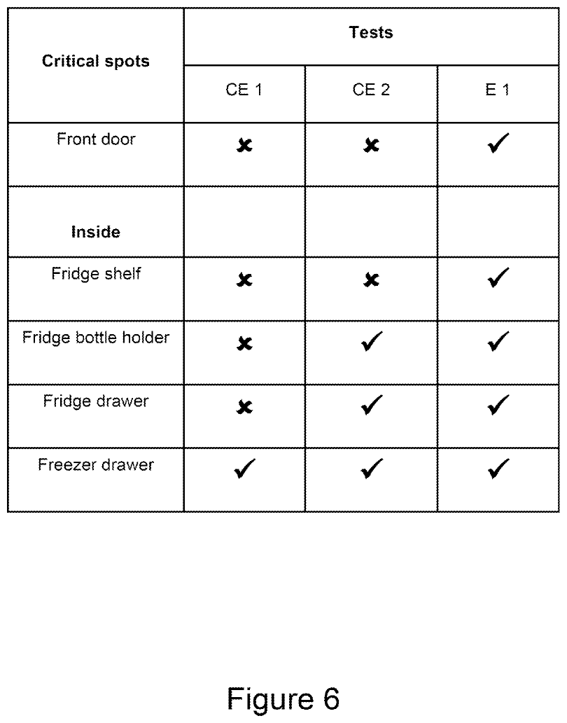

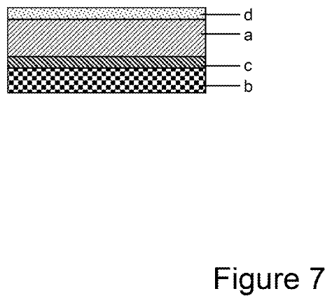

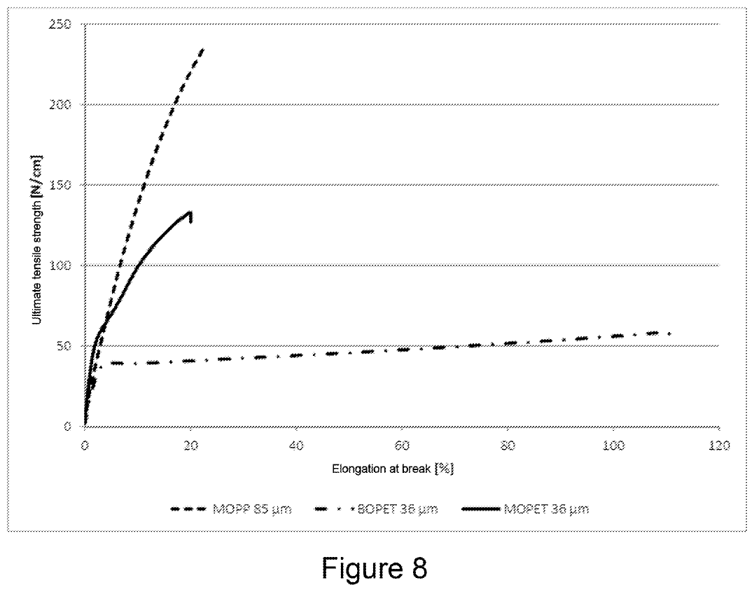

In addition, the advantageous mechanical properties can be demonstrated manually with the product. The adhesive tape applied to a table at one end, the free end of which measures about 20 cm from the edge of the table, is put under tension manually by pulling. If the adhesive tape is then partly cut/penetrated using scissors either directly at the side of the adhesive tape or in the middle of the width, and further mechanical stress is applied, MOPP or BOPET adhesive tapes tear even under gentle stress, whereas the MOPET adhesive tape withstands further stresses, for example by stronger pulling or boring with a sharp article.

This behavior was also observed in the vibration test. A damaged MOPET adhesive tape withstands the complete test cycles, whereas BOPET and MOPP tear, stretch excessively or are subject to adhesive failure.

### TEST METHODS

The measurements (unless stated otherwise) are conducted under test conditions of 23±1° C. and 50±5% rel. air humidity.

### VIBRATION TEST

In the vibration test, four refrigerators are tested for practical usability.

The test conditions can be found in DIN EN 60068-2-6:2008-10-00) and are defined as follows:
type of stress: sinusoidal
frequency range: 5 to 50 Hz
acceleration: 1 g
sweep time: 1.8 octave per minute
duration of vertical test: 20 sweeps=72 minutes
duration of horizontal test: 5 sweeps=18 minutes

### TENSILE TEST AND MODULUS OF ELASTICITY

Stress-strain characteristics are ascertained on type 2 test specimens (rectangular test strips of length 150 mm and, if possible, width 15 mm) according to DIN EN ISO 527-3/2/300:2003-07 at a test speed of 300 mm/min with a clamped length of 100 mm and an initial force of 0.3 N/cm, using sharp blades to cut specimens to size in order to ascertain the data.

Stress-strain characteristics, unless stated otherwise, are tested in machine direction (MD, running direction). The force is expressed in N/strip width and elongation at break in %. The test results, especially elongation at break, should be statistically confirmed by a sufficient number of measurements.

The measurement curve is used to ascertain ultimate tensile strength Fmax. Modulus of elasticity is ascertained from the force-elongation curve at low elongation.

### TEAR PROPAGATION RESISTANCE IN CROSS DIRECTION

Tear propagation is the force in N which is required for propagation of tearing of a specimen by a defined method. The measurement is in accordance with DIN EN ISO 6383-2:2004-10 (Part 2: Elmendorf method (ISO 6383-2:1983)).

A rectangular test specimen is used. The test results should likewise be statistically confirmed by a sufficient number of measurements.

### TENSILE IMPACT RESISTANCE IN CROSS DIRECTION

The measurement is in accordance with DIN EN ISO 8256:2005-05.

1. An adhesive tape comprising a carrier made of a film with an adhesive applied to at least one side thereof, wherein
the film is a film that has been monoaxially oriented in a longitudinal direction and contains polyester polymers to an extent of at least 90 wt %.

2. The adhesive tape as claimed in claim 1,
wherein
the film consists of polyester polymers to an extent of 100 wt %.

3. The adhesive tape as claimed in claim 1,
wherein
the polyester is polyethylene terephthalate or polyethylene terephthalate copolymer.

4. The adhesive tape as claimed in claim 1,
which exhibits a stretching ratio in an orientation in the longitudinal direction is between 1:3 and 1:10.

5. The adhesive tape as claimed in claim 1,
which exhibits a thickness of the film after orientation of between 20 and 150 μm.

6. The adhesive tape as claimed in claim 1,
which exhibits an ultimate tensile strength of the film at a thickness of 36 μm of between 120 and 160 N/cm, an elongation at break of between 20% and 40%, and/or a modulus of elasticity of between 8000 and 10,000 MPa.

7. The adhesive tape as claimed in claim 1,
wherein
an amount of adhesive applied to the carrier is between 15 and 60 g/m².

8. The adhesive tape as claimed in claim 1,
wherein
the adhesive is an acrylate-based adhesive or is selected from the group of natural rubbers or synthetic rubbers or from any blend of natural rubbers and synthetic rubbers.

9. The adhesive tape as claimed in claim 1,
wherein
the adhesive comprises tackifying resins, and the tackifying resins used are those based on hydrogenated, partly hydrogenated or unhydrogenated hydrocarbon resins, terpene-phenols, and rosin esters.

10. The adhesive tape as claimed in claim 1,
wherein
the adhesive contains at least one aging stabilizer and/or further blend components.

11. The adhesive tape as claimed in claim 1,
wherein
a isocyanate-based primer has been applied to the carrier prior to the application of the adhesive.

12. A method comprising securing of moving parts in a product selected from the group consisting of printers, copiers, domestic appliances, and furniture with a fixing adhesive tape, wherein the fixing adhesive tape is the adhesive tape as claimed in claim 1.

13. A method comprising bundling, packing, and/or palletizing a product, as securing means for transportation, and for strengthening of exposed and intricate edges with an adhesive tape, wherein the adhesive tape is the adhesive tape as claimed in claim 1.
